(19) United States
(12) Patent Application Publication
(10) Pub. No.: US 2018/0144551 A1
(43) Pub. Date: May 24, 2018

(54) INTERACTIVE DISPLAY DEVICE AND INTERACTIVE DISPLAY SYSTEM

(71) Applicant: Industrial Technology Research Institute, Hsinchu (TW)

(72) Inventors: Shih-Bin Luo, Hsinchu (TW); Chun-Chuan Lin, Hsinchu (TW)

(21) Appl. No.: 15/390,407

(22) Filed: Dec. 23, 2016

(30) Foreign Application Priority Data
Nov. 24, 2016 (TW) 105138621

(51) Int. Cl. G06T 19/00; G06T 7/70; G06T 3/40; H04N 9/31

(52) U.S. Cl. CPC G06T 19/006; H04N 9/3179; G06T 3/40; G06T 7/70

(57) ABSTRACT

An interactive display device and an interactive display system are provided. The interactive display device includes: a body having a microprocessor disposed therein; an optical project unit for projecting a pattern to a scene; an image capture unit for capturing an image of the scene containing the pattern; and a display unit for displaying the image. The interactive display device and the interactive display system can locate exactly through the image containing the pattern. Therefore, the present disclosure has the efficiency of easy communication.

### CROSS-REFERENCE TO RELATED APPLICATION

The present disclosure is based on, and claims priority from Taiwan Application Number 105138621, filed on Nov. 24, 2016, the disclosure of which is hereby incorporated by reference herein in its entirety.

### BACKGROUND

### 1. Technical Field

The present disclosure relates to display devices and display systems, and, especially, to an interactive display device and an interactive display system having image positioning capability.

### 2. Description of the Related Art

The emergence and popularization of head-mounted display (HMD) or smart glasses (such as Google glass) has been widely used in various fields, such as maintenance, disaster relief, medical treatment, surgery and other special fields. In these applications, the user can use the head-mounted display or smart glasses to obtain the immediate image, and transmit the image to remote ends to communicate with them. However, the user and the remote ends cannot accurately communicate with the image alone. For example, the precise location to be repaired or to be rescued cannot be described, but only a rough location indicated by up, down, left, and right directions with oral expressions. This not only results in longer communication time between the two sides, but also is more likely to cause time delay for repair or rescue.

Therefore, how to provide an interactive display device and an interactive display system having image positioning capability is one of the urgent issues to be solved.

### SUMMARY

An interactive display device is provided, comprising: a body having a microprocessor therein, an optical project unit provided on the body and controlled by the microprocessor for projecting a pattern to a scene; an image capture unit provided on the body and controlled by the microprocessor for capturing an image containing the pattern in the scene; and a display unit provided on the body for displaying the image.

An interactive display system is also provided, comprising an interactive display device and an electronic device, wherein the interactive display device comprises a body having a microprocessor therein, an optical project unit provided on the body and controlled by the microprocessor for projecting a pattern to a scene, an image capture unit provided on the body and controlled by the microprocessor for capturing an image containing the pattern in the scene, and a display unit provided on the body for displaying the image, and the electronic device is connected to the interactive display device through a network for receiving and displaying the image on a screen of the electronic device.

### BRIEF DESCRIPTION OF THE DRAWINGS

FIG. 1 is a three-dimensional schematic diagram illustrating a first embodiment of an interactive display device according to the present disclosure;

FIG. 2 is a three-dimensional schematic diagram illustrating a second embodiment of an interactive display device according to the present disclosure;

FIGS. 3A and 3B are schematic diagrams of an interactive display device according to the present disclosure;

FIG. 4 is a three-dimensional schematic diagram illustrating a third embodiment of an interactive display device according to the present disclosure;

FIG. 5 is a functional block diagram of an interactive display system according to the present disclosure; and

FIG. 6 is a schematic diagram of an interactive display system according to the present disclosure.

### DETAILED DESCRIPTION

The embodiments of the present disclosure are explained by following specific examples. One skilled in the art can readily comprehend other advantages and efficacies of the present disclosure in view of the disclosure of this specification. The present disclosure can also be implemented or applied by other specific examples.

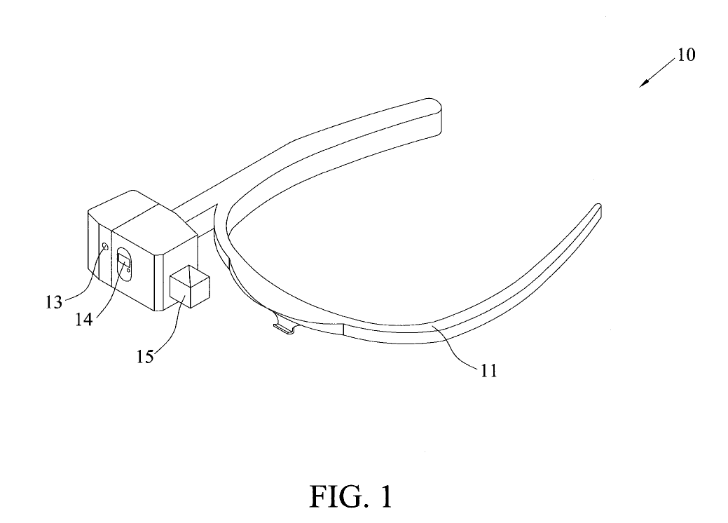

Referring to FIG. 1, an interactive display device 10 of a first embodiment according to the present disclosure includes a body 11, an optical project unit 13, an image capture unit 14, and a display unit 15. The body 11 may be an eyeglass, a mobile phone or a tablet computer. In an embodiment, the body 11 will be described as an eyeglass, but the present disclosure is not limited thereto.

As shown in FIG. 1, the optical project unit 13 is provided on the body 11, for example, on the right stand of a spectacle frame. The body 11 is provided with a microprocessor (not shown), and the optical project unit 13 is controlled by a microprocessor and can project a pattern to a scene.

The image capture unit 14 is also provided on the body 11, for example, on the right stand of a spectacle frame. The image capture unit 14 is also controlled by the microprocessor. After the optical project unit 13 projects the pattern to the scene, the image capture unit 14 captures the image containing the pattern in the scene.

The display unit 15 is also provided on the body 11, for example, in front of the position of the right lens of a spectacle. When a user wears the interactive display device 10, the right eye of the user can see the image displayed by the display unit 15. The arrangement positions of the optical project unit 13, the image capture unit 14, and the display unit 15 are merely examples, and the present disclosure is not limited thereto.

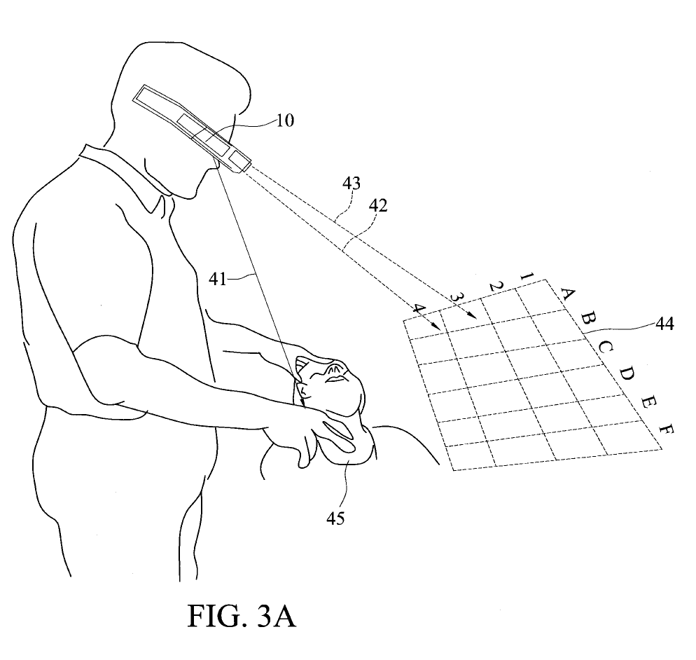

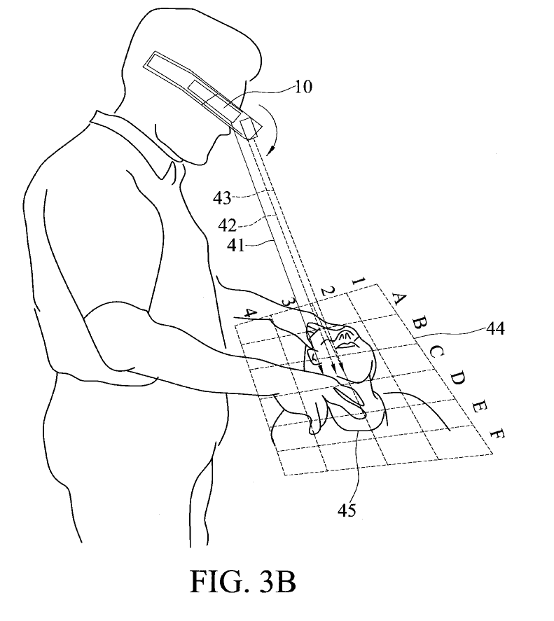

In an embodiment, the optical project unit 13 is a laser having a laser light source and a diffraction element, wherein the diffraction element may be an optical hologram or a microstructural optical film. The optical project unit 13 may project a pattern through a laser light source and a diffraction element, and the pattern is a checkerboard pattern or a concentric circle pattern. As shown in FIG. 3A, the pattern 44 is a checkerboard pattern, where the horizontal axis is marked by A to F and the vertical axis is marked by 1 to 4. Nevertheless, the present disclosure is not limited to the form of the pattern, nor the designations of the vertical and horizontal axes.

In an embodiment, the image capture unit 14 is a camera, which may comprise a color complementary metal-oxide-semiconductor (CMOS) image sensor or a color-coupled device (CCD) image sensor, but the disclosure is not limited thereto.

In an embodiment, the display unit 15 is a micro-display panel, such as a liquid-crystal display (LCD) or a panel produced by liquid crystal on silicon (LCOS) technology, with a virtual image magnifying optical element in the panel, which can magnify an image captured by the image capture unit 14 to a degree that users can view.

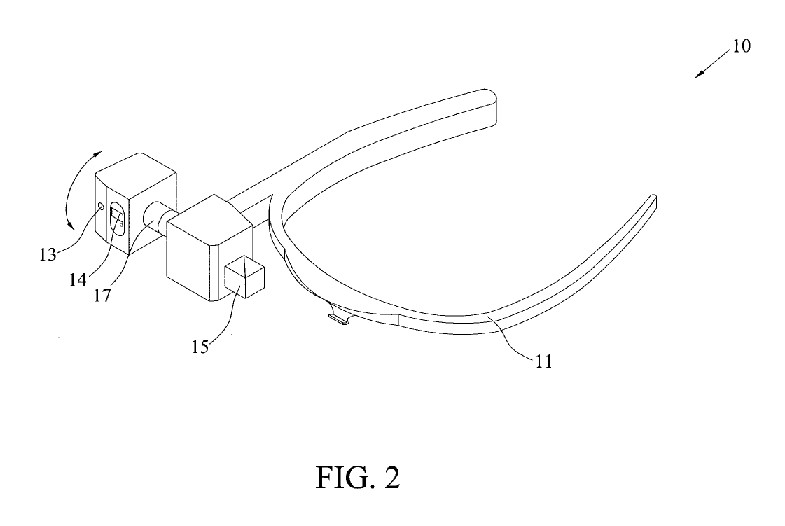

Please refer to the interactive display device 10 of a second embodiment according to the present disclosure illustrated by FIG. 2. Only the difference between the second embodiment and the first embodiment will be described. The interactive display device 10 of the second embodiment according to the present disclosure is different from the first embodiment in that the optical project unit 13 and the image capture unit 14 are not directly provided on the body 11. In an embodiment, the interactive display device 10 further includes an angle adjustment unit 17 provided on the body 11, for example, on a right stand of a spectacle frame, and the optical project unit 13 and the image capture unit 14 are connected to the body 11 through the angle adjustment unit 17.

In an embodiment, the angle adjustment unit 17 is a spindle motor, such that the optical projection unit 13 and the image pickup unit 14 can simultaneously rotate with respect to the body 11. The rotation method may be that the microprocessor inside the body 11 controls the spindle motor according to a tilt angle detected by a gyroscope inside the body 11 to further control the rotation angle of the optical project unit 13 and the image capture unit 14.

In another embodiment, the angle adjustment unit 17 may be a rotary shaft without power, and a user may manually adjust the rotation angles of the optical project unit 13 and the image capture unit 14.

The purpose of providing the angle adjustment unit 17 in the interactive display device 10 of the present disclosure is to align the line of sight of a user with the pattern projection direction of the optical project unit and the image capture direction of the image capture unit. Referring to FIG. 3A, after a user wears the interactive display device 10 according to the present disclosure and plans to project a pattern 44 in a scene 45, if the interactive display device 10 is not provided with the angle adjustment unit 17, the sight line 41 of the user is liable to be inconsistent with the pattern projection direction 42 of the optical project unit 13 and the image capture direction 43 of the image capture unit 14 when the user bows the head to look at the near scene 45. This is due to the viewing angle of the human eye is considerably large. To accurately project the pattern 44 onto the scene 45, the user obviously has to take a lower head posture, which is likely to cause neck discomfort. Therefore, as shown in FIG. 3B, the interactive display device 10 according to the present disclosure is provided with an angle adjustment unit 17 that projects the pattern 44 to the scene 45 by rotating the optical project unit 13 and the image capture unit 14. The user does not have to take a lower head position, and hence the interactive display device 10 does not incur a burden on the user.

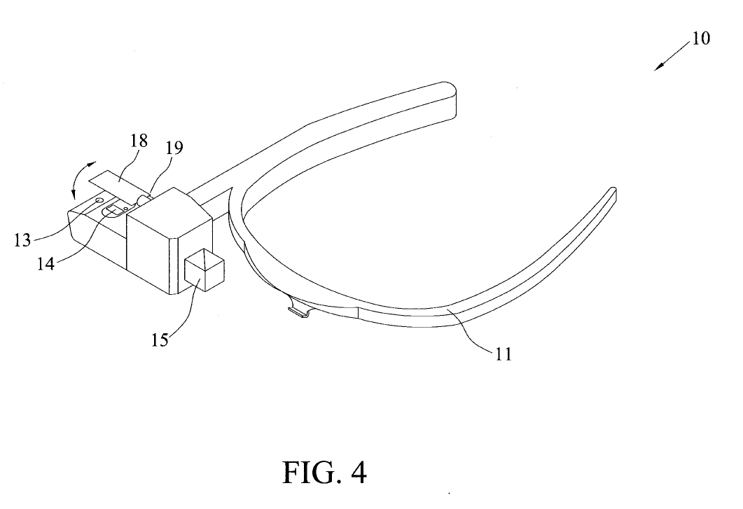

Please refer to the interactive display device 10 of a third example according to the present disclosure illustrated in FIG. 4. Only the difference between the third embodiment and the first embodiment will be described. The interactive display device 10 of the third example according to the present disclosure is different from the first embodiment in that the interactive display device 10 of the third embodiment further comprises a reflection unit 18. The reflection unit 18 is provided on the body 11 through a spindle motor 19, for example, on a right stand of a spectacle frame. In an embodiment, the optical project unit 13 and the image capture unit 14 are provided on the right stand of the spectacle frame, but below the reflection unit 18. That is, the reflection unit 18 is provided in the proceeding path of the pattern projection direction of the optical project unit 13 and the image capture direction of the image capture unit 14. In an embodiment, the reflective unit 18 may be a reflecting mirror, and may be used to change the pattern projection direction and the image capture direction. The method is that a microprocessor within the body 11 controls the spindle motor 19 according to a tilt angle detected by a gyroscope provided within the body 11 to further control the rotation angle of the reflection unit 18.

In an embodiment, the interactive display device 10 may further comprise a wireless transmission unit (not shown) for transmitting images to a terminal unit to display. In an embodiment, the wireless transmission unit may be configured to use Bluetooth, Wi-Fi, 3G or 4G wireless network transmission, but the disclosure is not limited thereto.

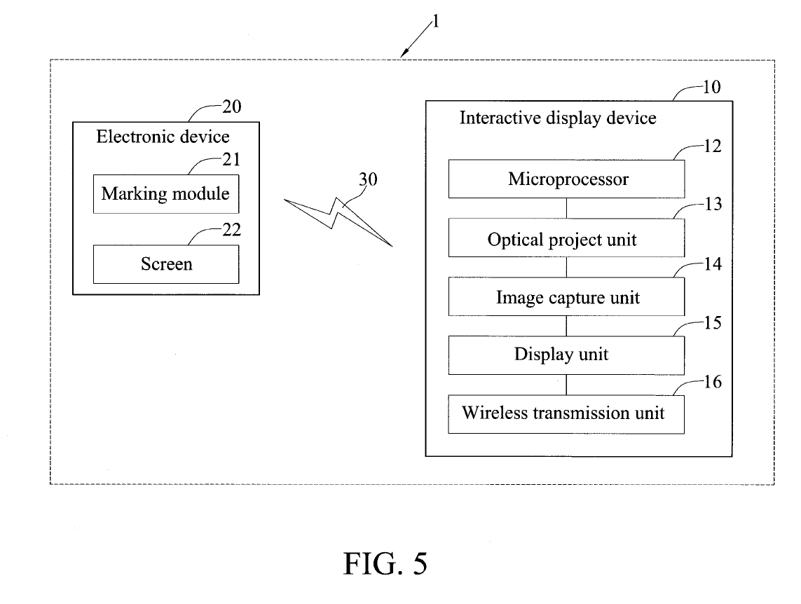

Referring to FIGS. 1 and 5, the interactive display system 1 according to the present disclosure comprises an interactive display device 10 and an electronic device 20. The interactive display device 10 comprises a body 11, an optical project unit 13, an image capture unit 14, and a display unit 15. The body 11 of the interactive display device 10 is provided with a microprocessor 12 for controlling the optical project unit 13 and the image capture unit 14. The detailed technical content of the interactive display device 10 has been described above and will not be described in detail here.

The electronic device 20 is connected to a wireless transmission unit 16 of the interactive display device 10 via a network 30 for receiving an image containing a pattern captured by the image capture unit 14 of the interactive display device 10. The electronic device 20 comprises a screen 22 on which images containing the patterns captured by the image capture unit 14 of the interactive display device 10 are displayed.

In an embodiment, the electronic device 20 is a mobile phone, tablet or desktop computer with a processor, and the network may be a Bluetooth, Wi-Fi, 3G or 4G wireless network.

In an embodiment, the electronic device 20 comprises a marking module 21. The module according to the present disclosure is a software that can be executed by a processor. The marking module 21 is used to mark an image, for example, editing the image by using an image software such as MS Paint. The tagged image can be transmitted via the network 30 to the interactive display device 10 and displayed on the display unit 15.

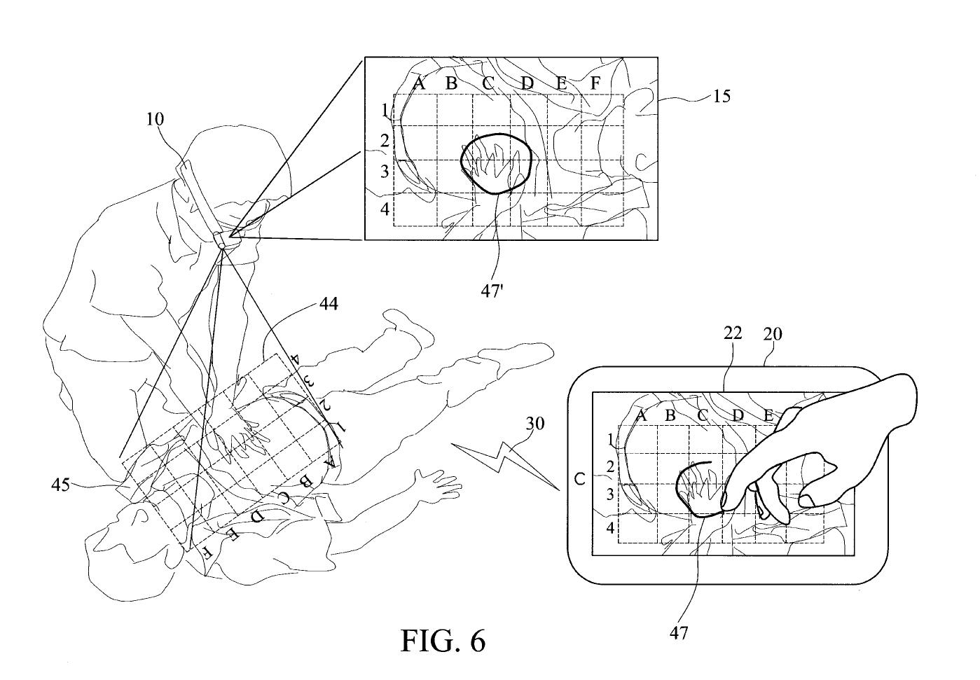

As shown in FIG. 6, when the interactive display system 1 according to the present disclosure is applied, a user wears the interactive display device 10 and projects a pattern 44 on a scene 45 (for example, a casualty), and the user can see the image containing the pattern 44 in the display unit 15. The interactive display device 10 transfers the captured image containing the pattern 44 to the electronic device 20 through the network 30 and displays the image on the screen 22 of the electronic device 20. The user viewing the electronic device 20 can easily communicate with the user wearing the interactive display device 10 based on the pattern 44 because the image contains the pattern 44 (for example, a checkerboard pattern), and both parties have common coordinate cognition. For example, the position of pressing C3 may be indicated. In an embodiment, the user viewing the electronic device 20 may make a mark 47 to the image on the screen 22 (e.g., draw a circle at the C3 position), and the marked image may be transmitted to the interactive display device 10 through the network 30 and displayed on the display unit 15. The user wearing the interactive display device 10 can see the mark 47′ in the image on the display unit 15. The precise position can be determined by the marks 47 and 47′ in the images such that communications of both sides can go more smoothly.

Although the interactive display device 10 according to the present disclosure is explained by taking an example of the body 11 as a spectacle, the body 11 of the interactive display device 10 according to the present disclosure may be a mobile phone or a tablet computer, the optical project unit 13 may be a plug-in project unit, the image capturing unit 14 may be a camera on a mobile phone or a tablet computer, and the display unit 15 may be a screen on a mobile phone or a tablet computer. The present disclosure is not limited thereto.

With the interactive display device and system according to the present disclosure, the optical project unit of the interactive display device can project a pattern, and the image capture unit of the interactive display device can capture an image containing the pattern, which can be transmitted to an electronic device, such that both sides of users can precisely position through the images containing the pattern. Moreover, users can also mark the images containing the pattern by a marking module of an electronic device. Therefore, the present disclosure has an effect of easy communication. In the application, young doctors can wear the interactive display device of the present disclosure for examining patients, and senior doctors can assist in determining patients' conditions by images containing a pattern displayed by the electronic device or mark the images for facilitating the communication between the two sides. The present disclosure can further be applied in the fields of maintenance, disaster relief, medical treatment and surgery as a bridge between the first-line user and the back-end support center.

The embodiments described above are only illustrative of the technical principles, features, and effects of the present disclosure, and are not intended to limit the scope of the present disclosure. Any person skilled in the art can, without departing from the spirit and scope of the present disclosure, modify and change the embodiments. However, any equivalent modifications and variations that can be made with the teachings of the present disclosure are intended to be encompassed by the following claims. And the scope of protection of the present disclosure is set forth in the following claims.

What is claimed is:

1. An interactive display device, comprising:
a body having a microprocessor therein;
an optical project unit provided on the body and controlled by the microprocessor for projecting a pattern to a scene;
an image capture unit provided on the body and controlled by the microprocessor for capturing an image containing the pattern in the scene; and
a display unit provided on the body for displaying the image.

2. The interactive display device according to claim 1, wherein the body is an eyeglass, a mobile phone or a tablet computer.

3. The interactive display device according to claim 1, wherein the optical project unit is a laser having a laser light source and a diffraction element.

4. The interactive display device according to claim 3, wherein the diffraction element is an optical whole-picture or a microstructural optical film.

5. The interactive display device according to claim 1, wherein the pattern is a checkerboard pattern or a concentric circle pattern.

6. The interactive display device according to claim 1, wherein the image capture unit is a camera including a color complementary metal semiconductor image sensor or a color photosensitive coupling element image sensor.

7. The interactive display device according to claim 1, wherein the display unit is a micro-display panel having a virtual image magnifying optical element.

8. The interactive display device according to claim 1, further comprising a wireless transmission unit configured for transmitting the image to a terminal unit to display, wherein the wireless transmission unit uses Bluetooth, Wi-Fi, 3G or 4G wireless network transmission.

9. The interactive display device according to claim 1, further comprising an angle adjustment unit provided on the body and connected to the optical project unit and the image capture unit such that the optical project unit and the image capture unit rotate simultaneously with respect to the body.

10. The interactive display device according to claim 9, wherein the angle adjustment unit is a spindle motor, and the microprocessor controls the spindle motor in accordance with a gyroscope provided in the body to control a rotation angle of the optical project unit and the image capture unit.

11. The interactive display device according to claim 1, further comprising a reflecting unit provided on the body and located in a pattern projection direction of the optical project unit and an image capture direction of the image capture unit for changing the pattern projection direction and the image capture direction.

12. The interactive display device according to claim 11, wherein the reflecting unit is provided on the body through a spindle motor, and the microprocessor controls the spindle motor in accordance with a gyroscope provided in the body to control a rotation angle of the reflection unit.

13. An interactive display system comprising:
an interactive display device comprising:
a body having a microprocessor therein;
an optical project unit provided on the body and controlled by the microprocessor for projecting a pattern to a scene;
an image capture unit provided on the body and controlled by the microprocessor for capturing an image containing the pattern in the scene; and
a display unit provided on the body for displaying the image; and
an electronic device connected to the interactive display device through a network to receive and display the image on a screen of the electronic device.

14. The interactive display system according to claim 13, wherein the body is an eyeglass, a mobile phone or a tablet computer, and the electronic device is a mobile phone, a tablet computer or a desktop computer.

15. The interactive display system according to claim 13, wherein the optical project unit is a laser having a laser light source and a diffraction element.

16. The interactive display system according to claim 15, wherein the diffraction element is an optical whole-picture or a microstructural optical film.

17. The interactive display system according to claim 13, wherein the pattern is a checkerboard pattern or a concentric circle pattern.

18. The interactive display system according to claim 13, wherein the image capture unit is a camera including a color complementary metal semiconductor image sensor or a color photosensitive coupling element image sensor.

19. The interactive display system according to claim 13, wherein the display unit is a micro-display panel having a virtual image magnifying optical element.

20. The interactive display system according to claim 13, wherein the interactive display device further includes a wireless transmission unit for being connected with the electronic device through the network, and the network is a Bluetooth, a Wi-Fi, 3G or 4G wireless network.

21. The interactive display system according to claim 13, wherein the interactive display device further comprises an angle adjustment unit provided on the body and connected to the optical project unit and the image capture unit such that the optical project unit and the image capture unit rotate simultaneously with respect to the body.

22. The interactive display system according to claim 21, wherein the angle adjustment unit is a spindle motor, and the microprocessor controls the spindle motor in accordance with a gyroscope provided in the body to control a rotation angle of the optical project unit and the image capture unit.

23. The interactive display system according to claim 13, wherein the interactive display device further comprises a reflecting unit provided on the body and located in a pattern projection direction of the optical project unit and an image capture direction of the image capture unit for changing the pattern projection direction and the image capture direction.

24. The interactive display system according to claim 23, wherein the reflecting unit is provided on the body through a spindle motor, and the microprocessor controls the spindle motor in accordance with a gyroscope provided in the body to control a rotation angle of the reflection unit.

25. The interactive display system according to claim 13, wherein the electronic device comprises a marking module for marking the image and the marked image can be transmitted to the interactive display device through the network and displayed on the display unit.
